(19) United States
(12) Patent Application Publication
(10) Pub. No.: US 2007/0183771 A1
(43) Pub. Date: Aug. 9, 2007

(54) Imaging apparatus and imaging unit

(76) Inventors: Tatsuo Takanashi, Tokyo (JP); Kazuo Mikami, Iruma-shi (JP); Yoji Watanabe, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/701,080

(22) Filed: Jan. 31, 2007

(30) Foreign Application Priority Data
Feb. 6, 2006 (JP) 2006-028762
Mar. 13, 2006 (JP) 2006-067111

(51) Int. Cl. G03B 19/00

(52) U.S. Cl. 396/429

(57) ABSTRACT

There is disclosed an imaging apparatus including an image pickup device, a dust proof member provided in front of the image pickup device, and a fluid pump having a piezoelectric element as a drive source to generate a flow of air toward the front surface of the dust proof member. The flow of air is used to remove dust adhering on the surface of the dust proof member. For example, the dust proof member can be configured as a low-pass filter or a transparent glass member arranged on an imaging optical path.

### CROSS-REFERENCE TO RELATED APPLICATION

This application is based upon and claims the benefit of priority from prior Japanese Patent Application Nos. 2006-028762, filed on Feb. 6, 2006 and 2006-067111, filed on Mar. 13, 2006, the entire contents of which are incorporated herein by reference.

### BACKGROUND OF THE INVENTION

1. Field of the Invention

The present invention relates to a dust removing device for image handling equipment. In particular, the present invention relates to an imaging apparatus and an imaging unit capable of removing dust adhering to the imaging unit for photoelectric conversion of subject images.

2. Description of the Related Art

In imaging equipment for capturing images, there is a problem that when dust adheres to optical elements into which a light flux is incident to form an image, image quality is reduced. In particular, among the optical elements, if dust adheres onto the imaging surface of an image pickup device or the surface of an optical element provided in front of the image pickup device, dust specks will appear in an image during imaging. For example, in case of a lens-interchangeable single-lens reflex camera, since dust can enter the inside of the camera from a mount opening upon changing lenses, or metal powder will fly in all directions due to friction in a focal-plane shutter, the dust speck problem is more likely to occur.

In order to deal with this dust adhesion problem, it is common practice to blow dust off with a blower or the like from the exposed surface of an imaging part in such a condition that an interchangeable lens is detached from the camera body. However, this method requires cumbersome operations to dust off the exposed surface of the imaging part, such as to detach the interchangeable lens and change the camera mode to a special mode.

Therefore, there is proposed a camera in which dust adhering to an optical element arranged in front of an image pickup device is blown off using a flow of air generated by a pump (Japanese Patent Application Laid-Open No. 2002-229110). In this camera, the pump arranged inside the camera is actuated to generate the flow of air using a driving force for quick-return operation of a movable mirror.

### BRIEF SUMMARY OF THE INVENTION

The imaging apparatus of the present invention has an image pickup device and a dust proof member provided in front of the image pickup device. In this structure, a fluid pump having a piezoelectric element as a drive source is provided to generate a flow of air toward the front surface of the dust proof member. The flow of air is used to remove dust adhering on the surface of the dust proof member. For example, the dust proof member can be configured as a low-pass filter or a transparent glass member.

The present invention can also be understood as either the invention of an imaging unit or the invention of a dust reduction device.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1 is a block diagram showing the general structure of a single-lens reflex digital camera according to each of embodiments of the present invention;

FIG. 2 is a sectional view showing the arrangement of an image pickup device unit and a piezoelectric pump in a first embodiment;

FIG. 3 is a flowchart showing a “power-on reset” routine of the single-lens reflex digital camera in each of the embodiments;

FIG. 4 is a flowchart showing an “imaging operation” subroutine in the first embodiment;

FIG. 5 is a sectional view showing the arrangement of a shutter in a charged state, a piezoelectric pump, and an image pickup device in a second embodiment;

FIG. 6 is a sectional view showing the arrangement of the shutter in an open state, the piezoelectric pump, and the image pickup device in the second embodiment;

FIG. 7 is a sectional view showing the arrangement of the shutter in such a state that a rear curtain is closed after the shutter is driven, the piezoelectric pump, and the image pickup device in the second embodiment;

FIG. 8 is a flowchart showing an “imaging operation” subroutine in the second embodiment;

FIG. 9 is a flowchart showing a “dust removal operation” subroutine in the second embodiment;

FIG. 10 is a sectional view showing a modification of the arrangement of the image pickup device unit and the piezoelectric pump of the first embodiment; and

FIG. 11 is a sectional view showing a modification of the arrangement of the image pickup device unit and the piezoelectric pump of the second embodiment.

### DETAILED DESCRIPTION OF THE PREFERRED EMBODIMENT

Preferred embodiments of the invention are described below with reference to the accompanying drawings.

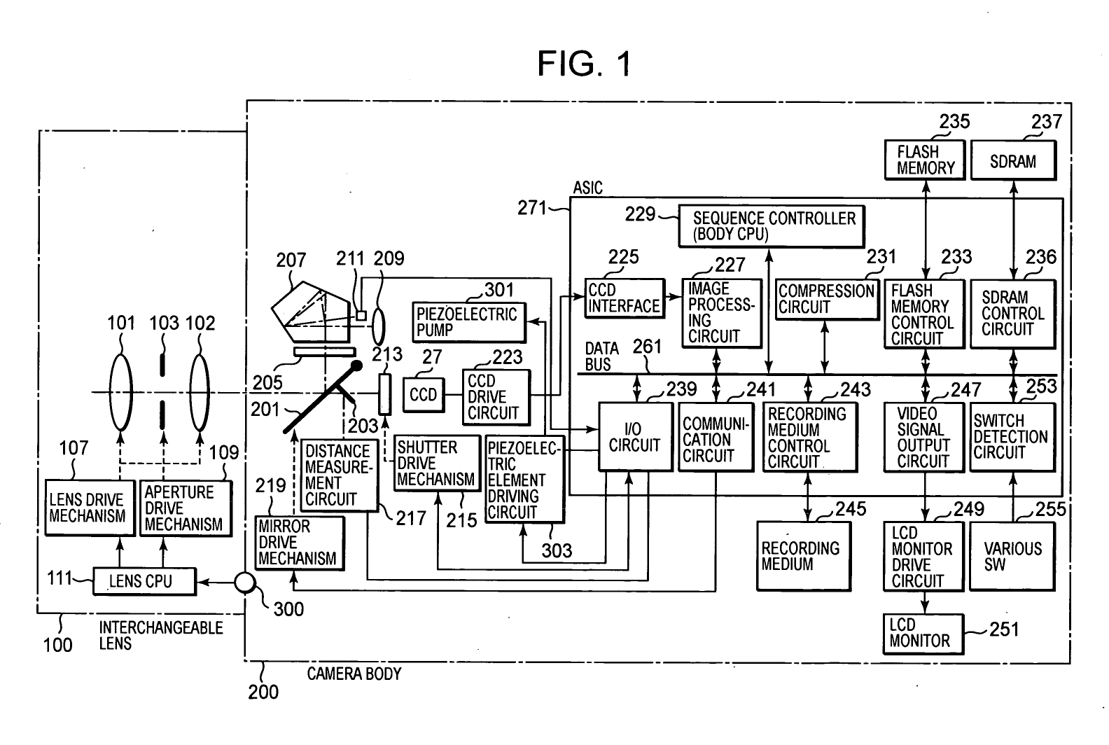

A first embodiment of a single-lens reflex digital camera to which the present invention is applied will now be described. FIG. 1 is a block diagram showing the general structure of a single-lens reflex digital camera according to a first embodiment of the present invention. The single-lens reflex digital camera according to the first embodiment consists principally of an interchangeable lens 100 and a camera body 200. In the first embodiment, the interchangeable lens 100 and the camera body 200 are constructed separately and electrically connected through a communication contact 300, but the interchangeable lens 100 and the camera body 200 can be integrally constructed.

Inside the interchangeable lens 100, lenses 101 and 102 for focusing adjustment and focal length adjustment, and an aperture 103 for adjusting the amount of light passing therethrough are arranged. The lenses 101, 102 and the aperture 103 are so connected that the lenses 101, 102 will be driven by a lens drive mechanism 107 and the aperture 103 will be driven by an aperture drive mechanism 109. The lens drive mechanism 107 and the aperture drive mechanism 109 are connected to a lens CPU 111, respectively, and the lens CPU 111 is connected to the camera body 200 through the connection contact 300. The lens CPU 111 controls the components inside the interchangeable lens 100. In other words, the lens CPU 111 controls the lens drive mechanism 107 to perform focusing and zoom driving, while it controls the aperture drive mechanism 109 to control the aperture value.

A movable mirror 201 is provided inside the camera body 200. The movable mirror 201 is movable between a position 45 degrees inclined with respect to the lens optical axis to reflect a subject image into a finder optical system and a position flipped up to guide the subject image to an image pickup device (CCD 227 to be described later). A focusing screen 205 is arranged above the movable mirror 201 to form the subject image thereon. A pentaprism 207 is arranged above the focusing screen 205 to flip the subject image horizontally left to right. An eyepiece lens 209 used for viewing the subject image is arranged on the exit side of the pentaprism 207 (on the right side in FIG. 1). A photometric sensor 211 is arranged at the side of the eyepiece lens 209 and in a position not to interfere with viewing of the subject image. The photometric sensor 211 includes multi-zone photometric elements for dividing the subject image and measuring the brightness of the subject image.

The central portion of the above-mentioned movable mirror 201 is formed into a half mirror. A sub-mirror 203 is provided on the backside of the movable mirror 201 to reflect a subject light flux passing through the half mirror portion downward in the camera body 200. This sub-mirror 203 is movable with respect to the movable mirror 201. In other words, when the movable mirror 201 is flipped up, the sub-mirror 203 is moved to a position to cover the half mirror portion, while when the movable mirror 201 is at the position for viewing the subject image, the sub-mirror 203 is at a position where it is perpendicular to the movable mirror 201 as shown in FIG. 1. This movable mirror 201 is driven by a mirror drive mechanism 219. Further, a distance measurement circuit 217 including a distance measurement sensor is arranged below the sub-mirror 203. This circuit is to measure the amount of defocus of the subject image formed from light passing through the lenses 101 and 102.

A focal-plane type shutter 213 for control of exposure time is arranged behind the movable mirror 201. The driving of this shutter 213 is controlled by a shutter drive mechanism 215. A CCD (Charge Coupled Devices) 27 as an image pickup device is arranged behind the shutter 213 to photoelectrically convert, into an electric signal, the subject image formed thereon from light passing through the lenses 101 and 102. In the embodiment, the CCD is used as the image pickup device, but the present invention is not limited thereto, and any other image pickup device such as a CMOS (Complementary Metal Oxide Semiconductor) can be used. A piezoelectric pump 301 using a piezoelectric element is arranged in the vicinity of this CCD 27. The piezoelectric pump 301 as a fluid pump provides a flow of air to blow off dust adhering to a low-pass filter (to be described later) integrally formed with the CCD. This piezoelectric pump 301 is connected to a piezoelectric element driving circuit 303 for driving the piezoelectric pump 301.

The CCD 27 is connected to a CCD drive circuit 223 in which analog-digital conversion (AD conversion) is performed. The CCD drive circuit 223 is connected to an image processing circuit 227 through a CCD interface 225. This image processing circuit 227 performs various image processing such as color correction, gamma (y) correction, contrast correction, etc.

The image processing circuit 227 is connected to a data bus 261 inside an ASIC (Application Specific Integrated Circuit) 271. Connected to this data bus 261 other than the image processing circuit 227 are, as will be described in detail later, a sequence controller (hereinafter referred to as “body CPU”) 229, a compression circuit 231, a flash memory control circuit 233, a SDRAM control circuit 236, an I/O circuit 239, a communication circuit 241, a recording medium control circuit 243, a video signal output circuit 247, and a switch detection circuit 253.

The body CPU 229 as a control part connected to the data bus 261 controls the overall flow of this single-lens reflex digital camera (electronic camera). The compression circuit 231 connected to the data bus 261 is a circuit for compressing image data stored in an SDRAM 237 using JPEG format. Note that the image compression format is not limited to JPEG, and any other compression method can be employed. The flash memory control circuit 233 connected to the data bus 261 is connected to a flash memory 235. This flash memory 235 stores a program for controlling the overall flow of the single-lens reflex camera, and the body CPU 229 controls the single-lens reflex digital camera according to the program stored in this flash memory 235. The flash memory 235 is an electrically rewritable nonvolatile memory. The SDRAM 237 is connected to the data bus 261 through the SDRAM control circuit 236. This SDRAM 237 is a memory for temporary storage of image data processed by the image processing circuit 227 or image data compressed by the compression circuit 231.

The I/O circuit 239 is connected with the above-mentioned photometric sensor 211, the shutter drive mechanism 215, the distance measurement circuit 217, the mirror drive mechanism 219, and the piezoelectric element driving circuit 303, respectively, to control input and output of data to and from each circuit such as the body CPU 229 through the data bus 261. The communication circuit 241 connected to the lens CPU 111 through the communication contact 300 is connected to the data bus 261 to communicate with the body CPU 229 and the like for exchange of data and communication of control instructions. The recording medium control circuit 243 connected to the data bus 261 is connected to a recording medium 245 to control the recording of image data and the like onto the recording medium 245. The recording medium 245 is a rewritable recording medium to be removably loaded into the camera body 200, such as an xD-Picture Card™, a Compact Flash™, an SD Memory Card™, or a Memory Stick™.

The video signal output circuit 247 connected to the data bus 261 is connected to an LCD monitor 251 through a LCD monitor drive circuit 249. The video signal output circuit 247 is a circuit for converting image data, stored in the SDRAM 237 or the recording medium 245, into a video signal for display on the LCD monitor 251. The LCD monitor 251 is arranged on the backside of the camera body 200, but the location thereof is not limited to the backside. The LCD monitor 251 can be arranged in any position as long as the photographer can view it, and be of any type other than the LCD type. Various switches 255, such as switches for detecting first and second strokes of a release button, a zoom switch for instructing the driving of a zoom lens, a bracketing mode switch for instructing a bracketing mode, etc., are connected to the data bus 261 through the switch detection circuit 253.

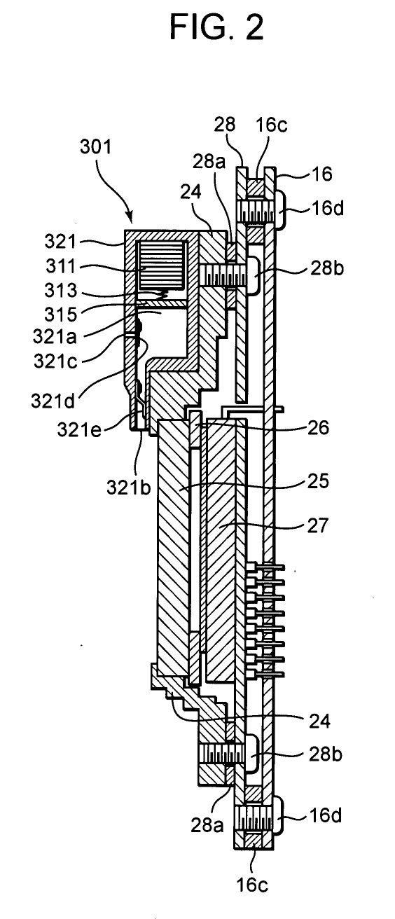

Referring next to FIG. 2, the arrangement of the image pickup device unit and the piezoelectric pump 301 as a fluid pump in the first embodiment will be described. As mentioned above, the CCD 27 as the image pickup device is a device for photoelectrically converting an image to output a photoelectrically converted signal. This CCD 27 is arranged adjacent to a low-pass filter 25, with a low-pass filter receiving member 26 sandwiched between the CCD 27 and the low-pass filter 25 in upper and lower edge portions of the CCD 27. This low-pass filter 25 is fitted in a step portion of an image pickup device storage case 24. An image pickup device fixing plate 28 is arranged behind the CCD 27 (on the right side in FIG. 2), and the image pickup device storage case 24 and the image pickup device fixing plate 28 are fastened together with screws 28b through a spacer 28a. Thus, the CCD 27 and the low-pass filter 25 are fixed while being sandwiched between the image pickup device storage case member 24 on the front side and the image pickup device fixing plate 28 on the rear side. The CCD 27 is kept in a sealed state by the low-pass filter 25, the image pickup device storage case 24, the image pickup device fixing plate 28, and the like so that dust cannot directly adhere to the CCD 27. A main substrate 16 is arranged behind the image pickup device fixing plate 28 to control the input and output of the CCD 27 and the like. This main substrate 16 and the image pickup device fixing plate 28 are integrally fastened together with screws 16d through a spacer 16c. The above-mentioned low-pass filter 25 is arranged in front of the CCD 27 to function as an optical element for allowing a light flux from a subject to pass through to form an image.

The piezoelectric pump 301 is arranged in an upper front portion of the imaging unit, and formed with a frame body 321 having a cavity therein. A nozzle 321b through which air enters and exists is an elongated tube-like hole with which an air reservoir chamber 321a having a large volume region communicates. The nozzle 321b is equipped with an exhaust valve 321e which allows a flow of air only to be exhausted from the inside. Further, an air inlet 321c is provided inside the air reservoir chamber 321a to allow air to flow in from the outside. To prevent air from leaking outward from this air inlet 321c, an outflow valve 321d is arranged to cover the air inlet 321c. A piezoelectric element 311 as a drive source to generate a flow of air is arranged in the back of the air reservoir chamber 321a. This piezoelectric element 311 is mounted to connect with a vibrating plate 315 through a spring 313 as an elastic member.

Since the vibration displacement (amplitude) of the piezoelectric element 311 of the piezoelectric pump 301 constructed as mentioned above is very small, natural vibration is used so that the piezoelectric element 311 will vibrate at a resonance frequency. If the elastic constant of the spring 313 is k and the mass of the vibrating plate 315 as a thin film is m, the natural frequency f of this piezoelectric pump 301 is given by:

$$f = \frac{1}{2 π} \sqrt{\frac{k}{m}}$$

If the piezoelectric element 311 is driven at this frequency f or a frequency in the neighborhood, it vibrates at a resonance frequency so that the displacement of the vibrating plate 315 can be made large and hence the amount of airflow exhausted from the piezoelectric pump 301 can be made large. This vibrating plate 315 can be unconfined to make it free to vibrate, or the vibrating plate 315 can be formed into a thin film to vibrate in such a condition that the perimeter of the thin film is fixed to the inner walls of the air reservoir chamber 312a.

The following describes the operation of the piezoelectric pump 301 as the fluid pump. When such a voltage to make the piezoelectric element 311 vibrate at the natural frequency of the vibrating plate 315 is applied to the piezoelectric element 311 to resonate therewith, the vibration is transmitted through the spring 313 to let the vibrating plate 315 resonate with the vibration of the piezoelectric element 311. This resonance also makes air in the air reservoir chamber 321a vibrate, so that a flow of air is amplified and blown out toward the surface of the low-pass filter 25 from the nozzle 321b as a narrow outflow path, thereby making it possible to blow off dust adhering on the low-pass filter 25. The total system can be configured such that the natural frequency of the piezoelectric element 311 itself is set as close as the natural frequency formed by the spring 313 and the vibrating plate 315 to improve efficiency.

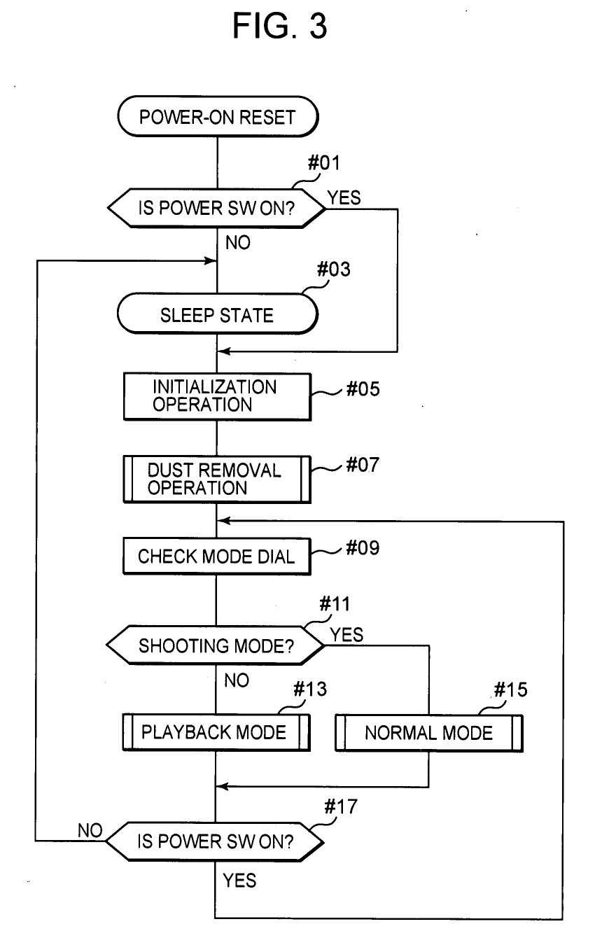

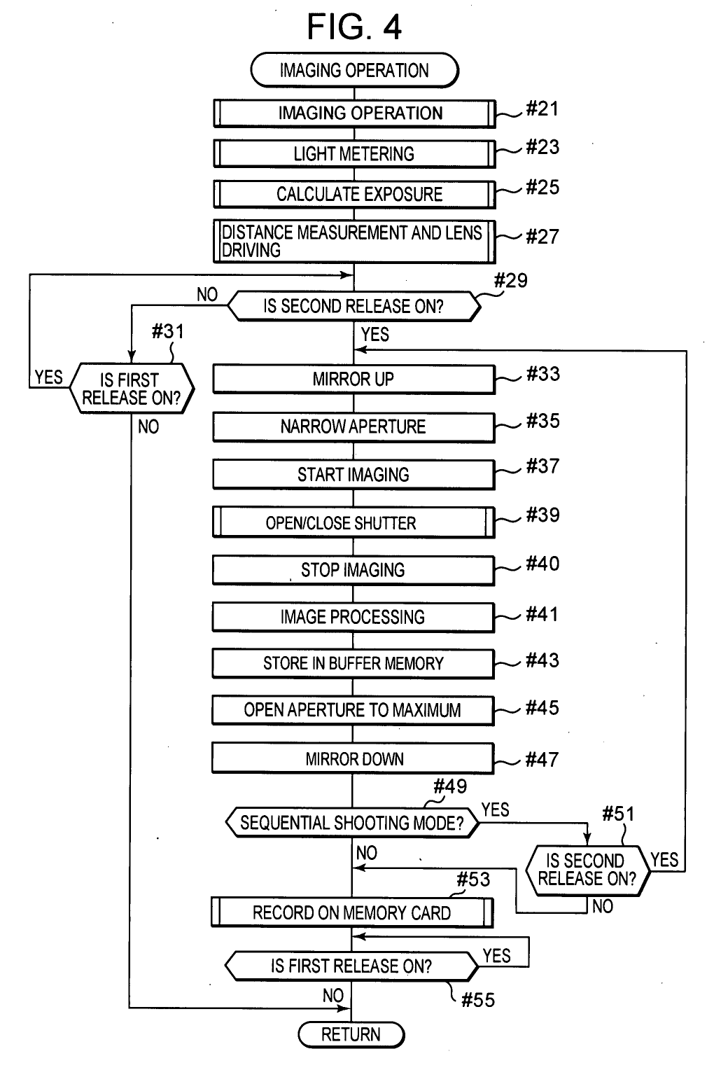

Referring next to flowcharts of FIGS. 3 and 4, the operation of the single-lens reflex digital camera of the first embodiment will be described.

First, when a battery is inserted into the camera body 200, the single-lens reflex digital camera starts a routine “power-on reset” as shown in FIG. 3 under the control of the body CPU 229. After the start of the routine, the camera first determines in step #01 whether a power switch (not shown) is on-state or not. If the power switch is off-state, the procedure goes to step #03 to enter a sleep state. In this sleep state, the body CPU 229 accepts an interrupt request only when the power switch is turned on. In other words, even if any other operation switch is operated, the body CPU 229 does not accept the interrupt request in the sleep state. The body CPU 229 performs processing only when the state of the power switch is changed, and this can prevent wasted power.

In step #01, if the power switch is on-state, or if the power switch is turned on in the sleep state, the procedure goes to step #05 to perform initialization. This initialization operation includes both electrical initialization and mechanical initialization. The electrical initialization is to reset various flags and counter values. The mechanical initialization is to move mechanical elements, such as the movable mirror 201 and the shutter 213, to their initial positions even if they remain stopped at intermediate positions for some reason without being fully driven. In the mechanical initialization, the state of each mechanism is first detected, and if stopped on its way, the mechanism is driven to return to its initial position. Then, a dust removal operation is performed by the piezoelectric pump 301 (#07). As mentioned above, this dust removal operation is to resonate the piezoelectric element 311 of the piezoelectric pump 301 at the natural frequency, so that a flow of air is blown toward the low-pass filter 25, thereby blowing dust off.

Next, based on the output of the switch detection circuit 253, the setting state of a mode dial provided in the camera body 200 is detected (#09). Then, the shooting mode is determined based on the detection result (#11). If the set mode is a playback mode, the procedure goes to step #13 to display an image on the LCD monitor 251 based on image data stored in the flash memory 235 or the SDRAM 237. On the other hand, if the mode determined in step #11 is a shooting related mode, such as a program shooting mode, an aperture priority shooting mode, a shutter speed priority mode, etc., the procedure goes to step #15 to perform processing according to the set mode. After completion of the processing in the playback mode (#13) or the shooting mode (#15), the on/off state of the power switch is determined again (#17). If the power switch is on-state, the procedure returns to step #09, while if the power switch is off-state, the camera returns to the sleep state (#03).

During the normal mode in step #15, if the release button is pressed halfway, the single-lens reflex digital camera enters an imaging operation under the control of the body CPU 229. The following describes this imaging operation with reference to FIG. 4.

When the camera enters the imaging operation, the above-mentioned dust removal operation is first performed (#21). Like in step #07, this dust removal operation is to blow a flow of air from the nozzle 321b of the piezoelectric pump 301 toward the low-pass filter 25 so as to blow dust off. Then, based on the output of the photometric sensor 211, the brightness of a subject is measured (#23). Then, based on the obtained subject brightness, the shutter speed and/or the aperture value are calculated (#25). After that, based on the output of the distance measurement circuit 217, the amount of defocus of the photographing lenses 101 and 102 is calculated to drive the lens drive circuit 107 through the lens CPU 111 based on the amount of defocus, thus performing a focusing operation.

After completion of the focusing of the photographing lens, it is determined whether the release button has been fully pressed to turn on a second release switch (#29). If the second release switch is not on-state, it is determined whether the release button has been pressed halfway to turn on a first release switch (#31). If it is determined that the first release switch is on-state, it means that the release button remains pressed halfway, but not pressed fully yet. Therefore, the camera enters a waiting state in which steps #29 and #31 are repeated. Then, in step #31, if the photographer has removed his or her finger from the release button to turn off the first release switch, the procedure follows the No branch to return to the power-on reset routine.

On the other hand, if the release button is fully pressed, the second release switch is turned on in step #29, so that actual imaging and recording of image data are performed through steps starting from step #33. First, the movable mirror 201 is flipped up (#33). As a result, light of the subject image passing through the photographing lenses 101 and 102 travels toward the CCD 27. Then, narrowing of the aperture 103 is started (#35), and imaging by the CCD 27 is started (#37). Concurrently, traveling of a front curtain of the shutter 213 is started, and after a predetermined period of time, traveling of a rear curtain is started (#39). After that, imaging by the CCD 27 is stopped (#40), the CCD drive circuit 223 reads out an image signal, and the image processing circuit 227 performs image processing (#41). The image data after subjected to this image processing is stored in the SDRAM 237 or the like as a buffer memory (#43). Then, the aperture 103 is returned to the maximum open state (#45), and the movable mirror 201 is flipped down (#47) to let a finder optical device enter a subject viewing state.

After that, it is determined whether the shooting mode is a sequential shooting mode (#49). If it is determined that the shooting mode is the sequential shooting mode, it is then determined whether the release button remains fully pressed (#51). If it is determined that the release button remains fully pressed, that is, when the second release switch remains on, the procedure returns to step #33 to repeat shooting. On the other hand, when the photographer removes his or her finger from the release button to turn off the second release switch, the sequential shooting is completed (No in step #51). If it is determined in step #49 that the shooting mode is not the sequential shooting mode or when the sequential shooting mode is completed, the procedure goes to step #53 in which image data recorded in the buffer memory such as the SDRAM 237 are recorded on the recording medium 245 (#53). Then, it is determined whether the release button remains pressed halfway, that is, whether the first release switch remains on (#55). If it remains on, the camera waits until the first release switch is turned off, and once it is turned off, the procedure returns to a power-on reset routine.

As described above, in the first embodiment, the piezoelectric pump 301 is arranged in the upper front of the imaging unit, but the present invention is not limited thereto. The piezoelectric pump 301 can be placed in any position as long as it can blow dust off using the air flow. For example, the piezoelectric pump 301 can be placed in a lower front of the imaging unit.

Further, in the first embodiment, only the piezoelectric pump 301 is provided as a generator for blowing a flow of air, but if a suction pump is provided in a lower portion of the imaging unit, the blown-off dust can get sucked in to prevent the dust particles from floating in a mirror box and adhering to the optical element (low-pass filter 25) again.

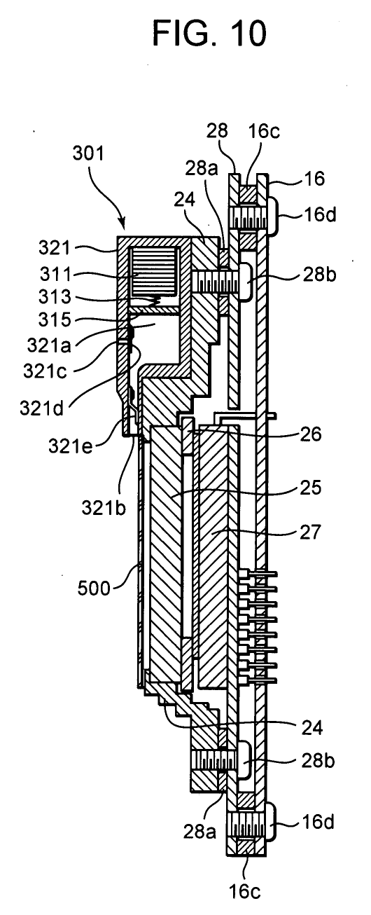

Further, in the first embodiment, the optical element that undergoes the dust removal operation is the low-pass filter 25, but the present invention is not limited thereto. Any other optical element, such as a cover glass protecting the CCD 27, an infrared cutoff glass, etc., can undergo the dust removal operation as long as the optical element is of the type that allows a light flux to pass through to form an image. For example, FIG. 10 shows another form in which a transparent glass 500 as a dust proof member is provided in front of the low-pass filter 25 to allow the light flux passing through the photographing lens to pass through toward the CCD in order to prevent dust from adhering to the front surface of the low-pass filter 25. Since this form has the same structure as the first embodiment except for this transparent glass, the description thereof is omitted here.

Further, in the first embodiment, the dust removal operation is performed when the power switch is turned on and during the imaging operation, but the present invention is not limited thereto. The dust removal operation can be performed at any time as appropriate. For example, the camera can be configured to further include a detection part for detecting that an accessory element such as an interchangeable lens has been mounted on the camera body so that the dust removal operation will be performed upon mounting the accessory element. Further, in the first embodiment, the dust removal operation during the imaging operation is performed after the release button is first pressed halfway and before light metering, but it can be performed at any time during a period from the half press of the release button until actual imaging is started.

Next, a second embodiment of the present invention will be described with reference to the accompanying drawings. Like the first embodiment, the second embodiment uses a single-lens reflex digital camera as the imaging apparatus. Here, the description of structural elements common to those in the first embodiment is omitted, and the features of the second embodiment are primarily described below.

Since the general structure of the single-lens reflex digital camera according to the second embodiment is the same as that of the first embodiment shown in the block diagram of FIG. 1, the description thereof is omitted.

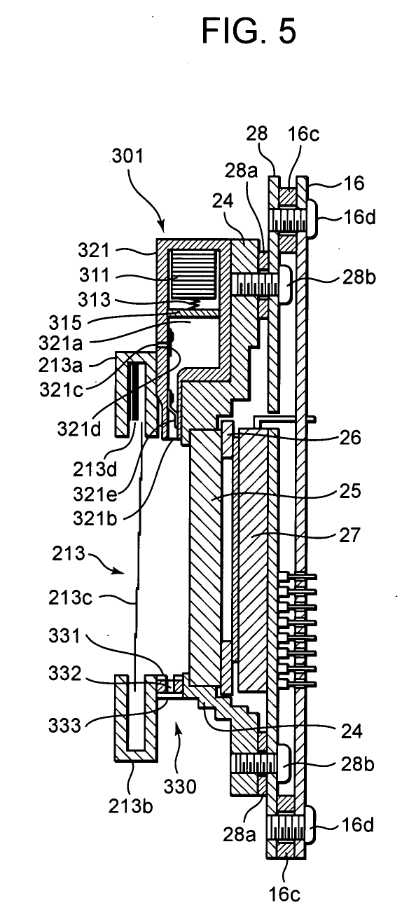

The following describes the structure of a piezoelectric pump 301 as a fluid pump in the second embodiment with reference to FIGS. 5 to 7. FIGS. 5 to 7 are sectional views showing the arrangement of the shutter, the piezoelectric pump, and the image pickup device in the second embodiment. A comparison between these figures and FIG. 2 shows that the second embodiment is the same as the first embodiment except that an air discharge part 330 is provided under the image pickup device storage case 24 and that the shutter 213 is shown in these figures. Therefore, the description of the portions common to those in FIG. 2 is omitted and the different points are primarily described below.

The air discharge part 330 is provided under the image pickup device storage case 24 in a position opposite to the piezoelectric pump 301. This air discharge part 330 is formed into an elongated box-like shape along the bottom of the image pickup device storage case 24. The air discharge part 330 has an adhesive agent 331, an outlet 332, and an air-cleaning filter 333. The adhesive agent 331 is applied on the upper surface of the air discharge part so that dust particles flowing through the flow of air into the air discharge part 330 will adhere to the adhesive agent 331. The outlet 332 that is also provided in the air discharge part 330 allows the flow of air to flow outward of the air discharge part 330. The air-cleaning filter 333 is provided on the bottom of the outlet 332 to filter the flow of air so that the flow of air with dust filtered out can be discharged. Thus, the flow of air is discharged after the dust is removed by the adhesive agent 331 and the air-cleaning filter 333 because, if not, the dust discharged from the air discharge part 330 could float in the camera body.

The shutter 213 is arranged outside of the piezoelectric pump 301 and the air discharge part 330 (on the left side corresponding to the photographing lens side in the figures). The shutter 213 has a shutter front curtain 213c, a shutter rear curtain 213d, and magazines (housing boxes) 213b and 213a. The shutter front curtain 213c consists of a plurality of shutter blades, which spread out horizontally to form a plane upon charging the shutter. The shutter rear curtain 213d consists of a plurality of shutter blades, which are folded upon charging the shutter. The magazine 213b houses the shutter front curtain 213c when the shutter is in an open state. The magazine 213a houses the shutter rear curtain 213d when the shutter is in the open state.

When the plurality of shutter blades are located in positions where they cover the shooting opening, the blades spread while overlapping one another as shown in FIG. 5. In this situation, the piezoelectric pump 301 is located near the side of the blade most close to the CCD 27 as the image pickup device in the plurality of shutter blades. Therefore, the shutter blades are so constructed not to get disturbed and not to move by a flow of air blown out from the piezoelectric pump 301.

As described in the first embodiment, the piezoelectric pump 301 as the fluid pump is driven at a resonance frequency.

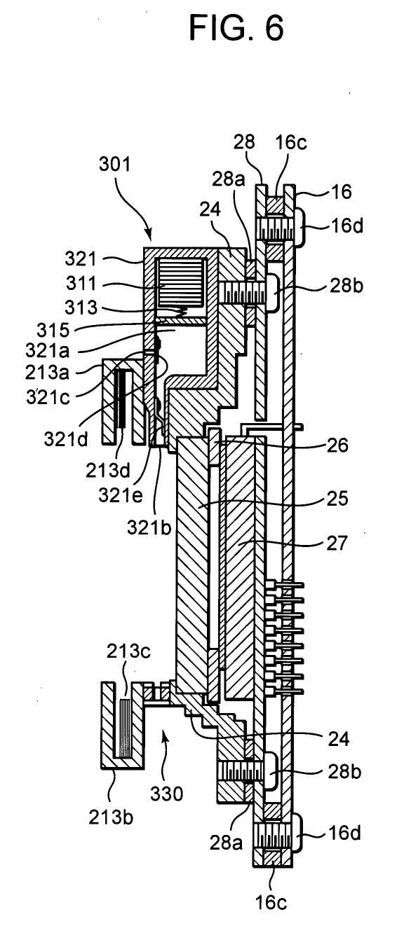

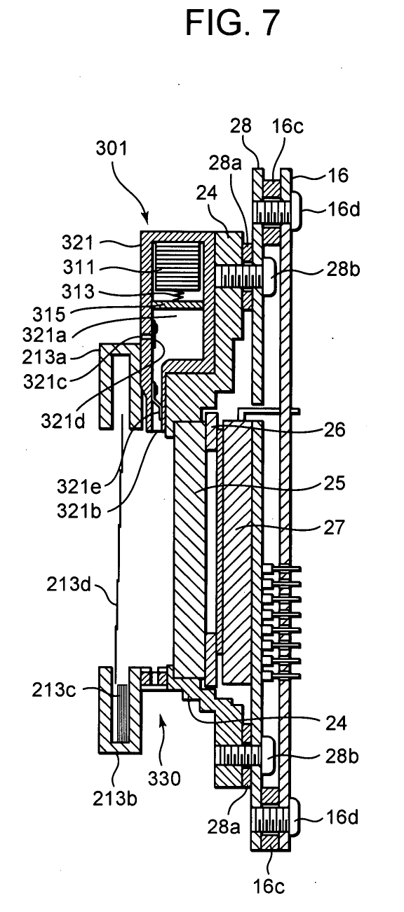

Referring next to FIGS. 5 to 7, the operation of the shutter 213 and the dust removal operation using a flow of air will be described. FIG. 5 shows a state in which the shutter 213 is charged. This state corresponds to a state of normal subject viewing. FIG. 6 shows a shutter open state for imaging operation. FIG. 7 shows a shatter closed state after the rear curtain travels from the shutter open state.

As shown in FIG. 5, in the normal subject viewing state, the shutter rear curtain 231d is housed in the magazine 213a, while the shutter front curtain 231c is located to block the light flux from the subject incoming through the photographing lenses 101 and 102. Under this condition, when a flow of air is blown out from the nozzle 321b of the piezoelectric pump 301, the air flows downward along the low-pass filter 25 in a closed space defined by the shutter front curtain 213c and the low-pass filter 25 to blow off dust particles adhering on the low-pass filter 25. The blown-off dust particles flow toward the air discharge part 330 and adhere to the adhesive agent 331 or are absorbed by the air-cleaning filter 333, so that they are less likely to fly again.

Upon start of the imaging operation, when the body CPU 229 instructs the shutter drive circuit 215 to start the traveling of the shutter front curtain 213c, the shutter front curtain 213c travels and is housed in the magazine 213b. In this state, as shown in FIG. 6, the light flux from the subject incoming through the photographing lenses 101 and 102 passes through the low-pass filter 25 to form an image on the CCD 27. Under this condition, when a flow of air is blown out from the nozzle 321b of the piezoelectric pump 301, the air flows downward along the low-pass filter 25 to blow off dust particles adhering on the low-pass filter 25, and the blown-off dust particles flow toward the air discharge part 330. Like in FIG. 5, the dust particles adhere to the adhesive agent 331 or are absorbed by the air-cleaning filter 333 so that they will not fly again.

When a predetermined shutter open period corresponding to the shutter speed has passed, the traveling of the shutter rear curtain 213d is started to move the shutter rear curtain 213d to a position as shown in FIG. 7 where it blocks the subject light flux incoming through the photographing lenses 101 and 102. After that, the shutter drive circuit 215 charges the shutter in accordance with an instruction from the body CPU 229 to return the shutter to the state shown in FIG. 5.

The operation of the single-lens reflex digital camera of this embodiment will next be described.

The control starting when the power switch is turned on is the same as a whole as that in the first embodiment shown in FIG. 3. The points in which the second embodiment differs from the first embodiment are the control of the shooting operation in the shooting mode in step #15 and the control of the dust removal operation in step #07.

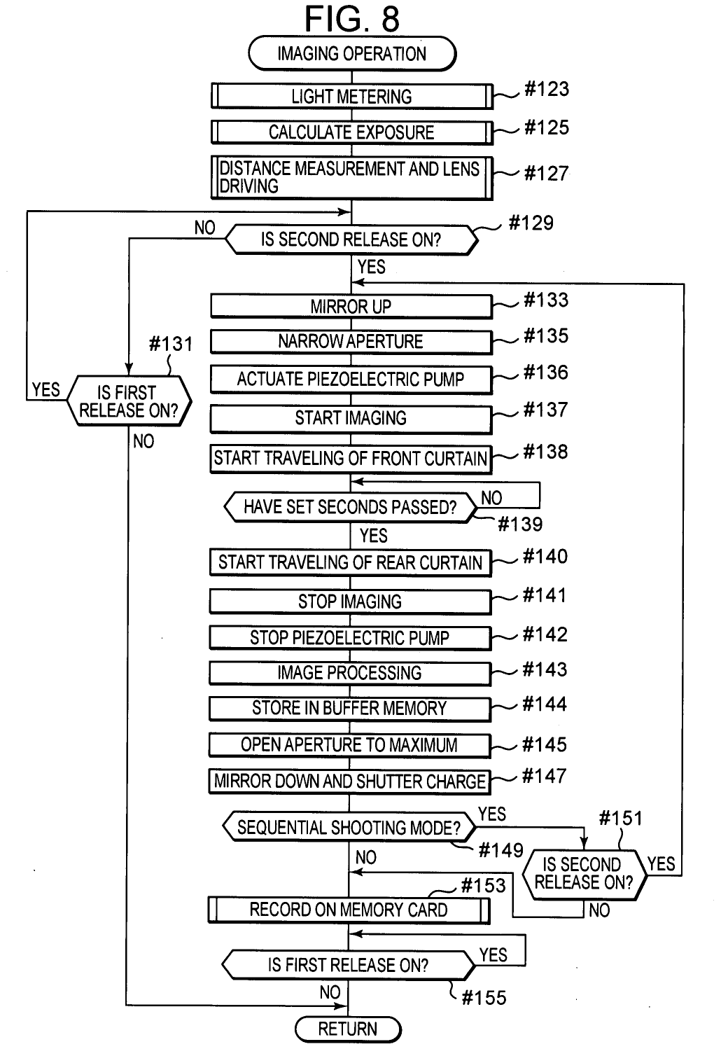

In the second embodiment, when the release button (not shown) is pressed halfway during the shooting mode in step #15, an imaging operation is performed. This imaging operation in the second embodiment will be described below with reference to FIG. 8.

When the camera enters the imaging operation, the brightness of a subject is first measured based on the output of the photometric sensor 211 (#123). Then, based on the obtained subject brightness, the shutter speed and/or the aperture value are calculated (#125). After that, based on the output of the distance measurement circuit 217, the amount of defocus of the photographing lenses 101 and 102 is calculated to drive the lens drive circuit 107 through the lens CPU 111 based on the amount of defocus, thus performing a focusing operation (#127).

After completion of the focusing of the photographing lens, it is determined whether the release button has been fully pressed to turn on a second release switch (#129). If the second release switch is not on-state, it is determined whether the release button has been pressed halfway to turn on a first release switch (#131). If it is determined that the first release switch is on-state, it means that the release button remains pressed halfway, but not pressed fully yet. Therefore, the camera enters a waiting state in which steps #129 and #131 are repeated. Then, in step #131, if the photographer has removed his or her finger from the release button to turn off the first release switch, the procedure follows the No branch to return to the power-on reset routine.

On the other hand, if the release button is fully pressed, the second release switch is turned on in step #129, so that actual imaging and recording of image data are performed through steps starting from step #133. First, the movable mirror 201 is flipped up (#133). As a result, a subject light flux passing through the photographing lenses 101 and 102 is guided to the shutter 213 side. Then, narrowing of the aperture 103 is started (#135), and the operation of the piezoelectric pump 301 is started (#136). As mentioned above, a flow of air is blown out from the nozzle 321b to brow off dust adhering on the low-pass filter 25.

After that, imaging by the CCD 27 to capture the subject image is started (#137), while the traveling of the front curtain 213c is started concurrently (#138). Then, the camera waits for a predetermined period of time (#139), and when the predetermined period of time has passed, the procedure goes to step #140 to start the traveling of the shutter rear curtain 213d (#140). Then, imaging by the CCD 27 is stopped (#141), and the blowing-out of the air flow by the piezoelectric pump 301 is stopped (#142).

At the time of starting the piezoelectric pump 301 in step #136, the space in the vicinity of the low-pass filter 25 is closed by the shutter front curtain 213c as shown in FIG. 5. Under this condition, the air is flowing between the shutter front curtain 213c and the low-pass filter 25 by means of the piezoelectric pump 301. Since the space is a narrow space closed therebetween, the air can flow efficiently along the surface of the low-pass filter 25. After the start and stop of the traveling of the shutter front curtain 213c in step #138, the space in the vicinity of the low-pass filter 25 is no longer closed by the shutter front curtain 213c as shown in FIG. 6. However, since the piezoelectric pump 301 blows the flow of air toward the low-pass filter 25, the air flows along the low-pass filter 25, enabling dust to be blown off. Then, after the start and stop of the traveling of the shutter rear curtain 213d, the space between the low-pass filter 25 and the shutter rear curtain 213d is closed again as shown in FIG. 7.

Thus, in the second embodiment, the dust removal operation of the piezoelectric pump 301 using the air flow is performed during steps #136 to #142, that is, during the imaging operation in the shutter open state and before and after the imaging operation. During the dust removal operation, even if some of the blown-off dust particles fly to block part of the passage of the subject light in front of the low-pass filter 25, the dust particles seldom appear in the resulting image as dust specks because they never stay stationary in one place.

After completion of stopping the piezoelectric pump in step #142, the CCD drive circuit 223 reads out an image signal of the CCD 27, and the image processing circuit 227 performs image processing (#143). The image data after subjected to this image processing is stored in the SDRAM 237 or the like as the buffer memory (#144). Then, the aperture 103 is returned to the maximum open state (#145), and the movable mirror 201 is flipped down and the shutter is charged (#147) to let the finder optical device enter the subject viewing state. The mirror-down is performed in such a manner that the body CPU 229 instructs the mirror drive mechanism 219 to move the movable mirror 201, which is at the flipped-up position during imaging, to the flipped-down position as shown in FIG. 1. Further, the shutter charge is performed mechanically in conjunction with the flipping down of the movable mirror 201 to shift from the state as shown in FIG. 7 where the traveling of the shutter rear curtain is completed to the shutter charge state as shown in FIG. 5. This mechanism is publicly known and hence the description thereof is omitted here.

Next, it is determined whether the shooting mode is the sequential shooting mode (#149). If it is determined that the shooting mode is the sequential shooting mode, it is then determined whether the release button remains fully pressed (#151). If it is determined that the release button remains fully pressed, that is, when the second release switch remains on, the procedure returns to step #133 to repeat shooting. On the other hand, when the photographer removes his or her finger from the release button to turn off the second release switch, the sequential shooting is completed (No in step #151). If it is determined in step #149 that the shooting mode is not the sequential shooting mode or when the sequential shooting mode is completed, the procedure goes to step #153 in which image data recorded in the buffer memory such as the SDRAM 237 are recorded on the recording medium (memory card) 245 (#153). Then, it is determined whether the release button remains pressed halfway, that is, whether the first release switch remains on (#155). If it remains on, the camera waits until the first release switch is turned off, and once it is turned off, the procedure returns to a power-on reset routine.

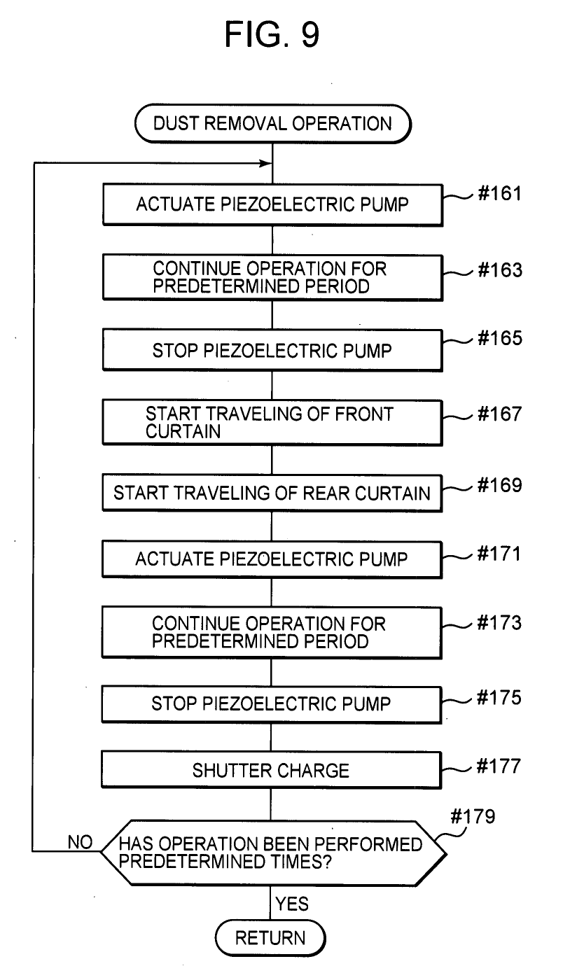

Next, the dust removal operation upon power on or in step #07 of FIG. 3 after initialization operation will be described with reference to FIG. 9.

First, the piezoelectric pump 301 is actuated to blow a flow of air from the nozzle 321b (#161) in order to perform dust removal using the air flow in the manner as mentioned above. In other words, as shown in FIG. 5, the air flows in the closed space defined by the shutter front curtain 213c and the low-pass filter 25 toward the air discharge part 330 to blow off dust adhering on the low-pass filter 25. After this operation is continued for a predetermined period of time, the piezoelectric pump 301 is stopped (#163 and #165).

After that, the traveling of the shutter front curtain 213c is started (#167), and then the traveling of the shutter rear curtain 213d is started (#169). After completion of the operation of the shutter 213, the piezoelectric pump 301 is actuated again for a predetermined period of time (#171 to #175) to remove dust by the flow of air. This time of actuation of the piezoelectric pump 301 is performed because the metal and/or plastic materials of the shutter 213 are in friction during the operation of the shutter 213 to cause metal and/or plastic powder as dust. Therefore, the shutter 213 is operated in advance during the actuation of the piezoelectric pump 301 upon power on and after initialization operation to remove dust resulting form the operation of the shutter 213. After stopping the piezoelectric pump 301, the shutter 213 is charged (#177). Then, it is determined whether this dust removal operation has been performed predetermined times. If it has not been performed predetermined times, the procedure returns to step #161 to repeat the above-mentioned operation steps. On the other hand, if it has been performed predetermined times, the procedure returns to the power-on reset routine in FIG. 3.

As described above, according to the second embodiment, there are provided the CCD 27 as the image pickup device, the dust proof member consisting of the low-pass filter 25 and the like, the piezoelectric pump 301 as the fluid pump for generating a flow of air toward the surface of this dust proof member, and the shutter 213 for opening/closing the shooting opening. Then, at least when the shutter 213 is closed, the piezoelectric pump 301 is controlled to generate the flow of air (#136 to #138, #140 to #142, #161 to #165, and #171 to #175) to remove dust. Therefore, dust adhering on the imaging part can be removed timely in a simple structure.

Further, in the second embodiment, the shutter 213 is a focal-plane shutter having the shutter front curtain 213c formed by laminating the plurality of blades, and the shutter rear curtain 213d formed by laminating the plurality of blades, and is arranged in the vicinity of the dust proof member with a predetermined space therebetween. Therefore, the flow of air from the piezoelectric pump 301 can be generated efficiently.

Further, in the second embodiment, since the air flow is generated by the piezoelectric pump 301 when the shutter front curtain 213c or the shutter rear curtain 213d is in the position to close the shooting opening, the air can flow in the closed space defined between the shutter curtain and the dust proof member, thereby enabling efficient dust removal.

Further, in the second embodiment, the piezoelectric pump 301 generates and blows the air flow from the side of the blade most close to the image pickup device in the plurality of blades under such condition that the shutter 213 is formed of the laminated blades and at least the shutter front curtain 213c or the shutter rear curtain 213d is in the closed state, thereby preventing the blades from getting disturbed by the air flow.

Further, in the second embodiment, the actuation of the piezoelectric pump 301 is started in such a condition that the shutter 213 is closed (#136), and then continued to generate the air flow even during the driving of the shutter 213 (#138 to #149). This can reduce the influence of dust during imaging and hence the danger of dust specks in images.

Further, in the second embodiment, the air-flow generating operation of the piezoelectric pump 301 and the shutter driving operation are repeatedly performed in the initial state of the single-lens reflex camera as the imaging apparatus (#07 and #161 to #179). Therefore, dust removal in the imaging apparatus can be performed in a timely manner.

Further, in the second embodiment, the piezoelectric pump 301 is actuated prior to the imaging operation (#136) and stopped after the imaging operation (#142). This can reduce the influence of dust during imaging and hence the danger of dust specks in images.

Further, in the second embodiment, the piezoelectric pump 301 is actuated after the operation of the shutter 213 (#167 to #175). This can remove dust caused by friction in the shutter in advance.

Further, in the second embodiment, since the outlet 332 capable of letting the air flow out is provided in a position opposite to the piezoelectric pump 301, the flow of air blown out by the piezoelectric pump 301 flows toward the outlet, so that dust will be discharged or allowed to adhere to the adhesive agent, thereby enabling prevention of dust from flying in the camera body.

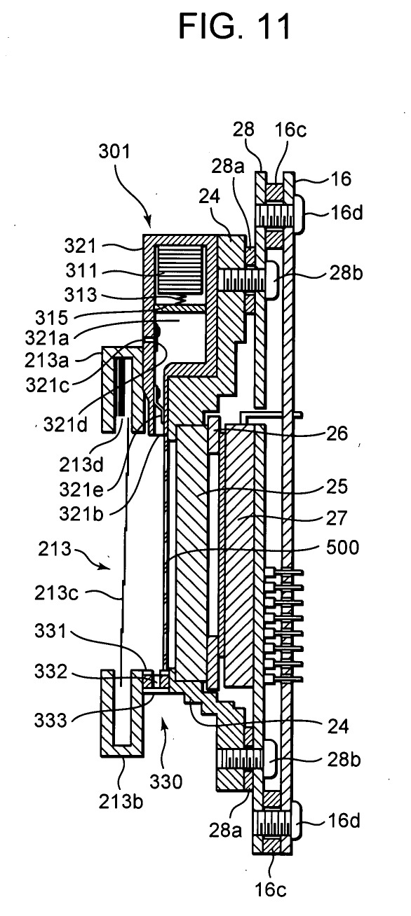

In the second embodiment as mentioned above, the piezoelectric pump 301 is used as the fluid pump, but the present invention is not limited thereto, and any other device can be used as long as it can generate a flow of air. Further, in the second embodiment, the dust proof member or the optical element that undergoes the dust removal operation corresponds to the low-pass filter 25, but the present invention is not limited thereto. Any other optical element, such as a cover glass protecting the CCD 27, an infrared cutoff glass, etc., can undergo the dust removal operation as long as the optical element is of the type that allows a light flux to pass through to form an image. For example, FIG. 11 shows another form in which a transparent glass 500 as a dust proof member is provided in front of the low-pass filter 25 to allow the imaging light flux passing through the photographing lens to pass through toward the CCD in order to prevent dust from adhering to the front surface of the low-pass filter 25. Since this form has the same structure as the second embodiment except for this transparent glass, the description thereof is omitted here.

Further, in the second embodiment, the piezoelectric pump 301 is arranged in the upper front portion of the imaging unit, but the present invention is not limited thereto. The piezoelectric pump 301 can be placed in any other portion as long as it can blow a flow of air to blow dust off. For example, the piezoelectric pump 301 can be arranged in a lower front portion of the imaging unit, or on either the right or left side thereof. In such a case, the air discharge part 330 is arranged in a position opposite to the piezoelectric pump 301.

Further, in the second embodiment, only the outlet 332 is provided for discharging the flow of air, but if a discharge or suction pump is provided, the blown-off dust can be collected efficiently, thereby enabling further prevention of dust particles from floating in a mirror box and adhering to the optical element (low-pass filter 25) again.

Further, in the second embodiment, the dust removal operation is performed during the initialization operation after the power switch is turned on and during the imaging operation, but the present invention is not limited thereto. The dust removal operation can be performed at any time as appropriate. For example, the camera can be configured to further include a detection part for detecting that an accessory element such as an interchangeable lens has been mounted on the camera body so that the dust removal operation will be performed upon mounting the accessory element.

Further, in the second embodiment, the dust removal operation during the imaging operation is performed during actual imaging after the shutter is opened, but it can be performed at any time during a period from the half press of the release button until actual imaging is completed.

Each of the aforementioned embodiments shows an example in which the present invention is applied to a single-lens reflex digital camera, but the present invention is not limited thereto. For example, the present invention can also be applied to a lens interchangeable rangefinder digital camera or a normal compact digital camera as well as the single-lens reflex digital camera. In particular, the present invention can be effectively applied to an imaging apparatus that may allow dust to enter the camera body from the outside when the lens or any other member is detached and hence the image pickup device or the optical element is exposed.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. An imaging unit provided with a dust reduction device comprising:
an image pickup device;
a dust proof member provided in front of the image pickup device; and
a fluid pump having a piezoelectric element as a drive source to generate a flow of air toward the front surface of the dust proof member.

2. The imaging unit according to claim 1 wherein the dust proof member is a low-pass filter.

3. The imaging unit according to claim 1 wherein the dust proof member is a transparent glass member.

4. An imaging unit provided with a dust reduction device for an imaging apparatus, comprising:
an image pickup device;
a dust proof member provided in front of the image pickup device; and
a fluid pump having a piezoelectric element as a drive source to generate a flow of air toward the front surface of the dust proof member.

5. The imaging unit according to claim 4 wherein the dust proof member is a low-pass filter.

6. The imaging unit according to claim 4 wherein the dust proof member is a transparent glass member.

7. An imaging apparatus comprising:
an image pickup device;
a dust proof member provided in front of the image pickup device; and
a fluid pump having a piezoelectric element as a drive source to generate a flow of air toward the front surface of the dust proof member.

8. The imaging apparatus according to claim 7 wherein the dust proof member is a low-pass filter.

9. The imaging apparatus according to claim 7 wherein the dust proof member is a transparent glass member.

10. A dust reduction device comprising:
a dust proof member through which a light flux passes to form an image;
a fluid pump having a piezoelectric element as a drive source to generate a flow of air toward the front surface of this optical member; and
a control part for controlling the fluid pump to remove dust adhering on the dust proof member using the flow of air.

11. The dust reduction device according to claim 10 wherein the dust proof member is a low-pass filter.

12. The dust reduction device according to claim 10 wherein the dust proof member is a transparent glass member.

13. The dust reduction device according to claim 10 further comprising a vibrating plate for driving a fluid, wherein the piezoelectric element of the fluid pump resonates at a natural frequency of the vibrating plate.

14. The dust reduction device according to claim 10 wherein the fluid pump includes a vibrating plate internally mounted to connect therewith through the piezoelectric element and an elastic member.

15. The dust reduction device according to claim 10 wherein the fluid pump internally includes an air reservoir chamber and a nozzle communicating with the air reservoir chamber.

16. The dust reduction device according to claim 15 wherein an air inlet is provided in the air reservoir chamber of the fluid pump and an outflow preventing valve is provided to prevent leakage of air from the air inlet.

17. The dust reduction device according to claim 15 wherein an inflow preventing valve is provided in the nozzle of the fluid pump to prevent the entry of air from the nozzle.

18. An imaging apparatus comprising:
a lens for forming an image of a subject;
an image pickup device for photoelectrically converting the image formed through the lens;
a dust proof member through which a light flux passes to form the image;
a fluid pump having a piezoelectric element as a drive source to generate a flow of air toward the front surface of the dust proof member; and
a control part for controlling the fluid pump to remove dust adhering on the dust proof member using the flow of air.

19. The imaging apparatus according to claim 18 wherein the dust proof member is a low-pass filter.

20. The imaging apparatus according to claim 18 wherein the dust proof member is a transparent glass member.

21. The imaging apparatus according to claim 18 wherein the control part performs dust removal using the flow of air when a power switch of the imaging apparatus is turned on.

22. The imaging apparatus according to claim 18 wherein the control part performs dust removal using the flow of air prior to an imaging operation.

23. The imaging apparatus according to claim 18 wherein the lens of the imaging apparatus is of an interchangeable type, and the control part performs dust removal using the flow of air when the lens is mounted on a body of the imaging apparatus.

24. An imaging apparatus comprising:
an image pickup device for acquiring an image signal corresponding to light irradiated on a photoelectric conversion surface thereof;
a dust proof member arranged to face the image pickup device with a predetermined space therebetween;
a fluid pump for generating a flow of air toward the surface of the dust proof member;
a shutter for opening and closing a shooting opening toward the image pickup device; and
a control part for controlling the fluid pump to generate the flow of air at least when the shutter is in a closed state.

25. The imaging apparatus according to claim 24 wherein the dust proof member is a low-pass filter.

26. The imaging apparatus according to claim 24 wherein the dust proof member is a transparent glass member.

27. The imaging apparatus according to claim 24 wherein the shutter is a focal-plane shutter having a front curtain formed by laminating a plurality of blades and a rear curtain formed by laminating a plurality of blades, the shutter arranged in the vicinity of the dust proof member with a predetermined space therebetween.

28. The imaging apparatus according to claim 27 wherein the control part controls the fluid pump to generate the flow of air when the front curtain or the rear curtain is located in such a closed position to close the shooting opening.

29. The imaging apparatus according to claim 27 wherein the fluid pump generates the flow of air from a side of the position of a blade most close to the image pickup device side in the plurality of blades in such a condition that the front curtain or the rear curtain is located in the closed position.

30. The imaging apparatus according to claim 24 wherein the control part starts actuation of the fluid pump at least when the shutter is in the closed state, and after that, controls the fluid pump to continuously generate the flow of air during driving of the shutter.

31. The imaging apparatus according to claim 24 wherein the control part repeatedly performs the air-flow generating operation of the fluid pump and the shutter driving operation in an initial state of the imaging apparatus.

32. The imaging apparatus according to claim 24 wherein the control part actuates the fluid pump prior to an imaging operation of the imaging apparatus, and stops the fluid pump after completion of the imaging operation.

33. An imaging apparatus comprising:
a dust proof member through which a light flux from a subject incoming through a photographing lens passes to form an image;
an image pickup device for receiving the subject light flux and photoelectrically converting the subject image;
a shutter arranged between the photographing lens and the dust proof member;
a fluid pump arranged between the shutter and the dust proof member to generate a flow of air; and
a control part for controlling the fluid pump to remove dust adhering on the dust proof member using the flow of air.

34. The imaging apparatus according to claim 33 wherein the dust proof member is a low-pass filter.

35. The imaging apparatus according to claim 33 wherein the dust proof member is a transparent glass member.

36. The imaging apparatus according to claim 33 wherein the control part actuates the fluid pump to remove the dust while the shutter is being closed.

37. The imaging apparatus according to claim 33 wherein the control part actuates the fluid pump to remove the dust after the shutter is operated.

38. The imaging apparatus according to claim 33 wherein the imaging apparatus includes an outlet arranged in a position opposite to the fluid pump and capable of letting the air flow out.

39. An imaging unit comprising:
a dust proof member through which a light flux passes to form an image;
an image pickup device for receiving the light flux and photoelectrically converting an image formed based on the light flux;
a shutter for opening and closing an opening through which the light flux enters toward the image pickup device; and
a fluid pump arranged between the shutter and the dust proof member to generate a flow of air.

40. The imaging unit according to claim 39 wherein the dust proof member is a low-pass filter.

41. The imaging unit according to claim 39 wherein the dust proof member is a transparent glass member.
